(19) United States
(12) Patent Application Publication
(10) Pub. No.: US 2025/0174033 A1
(43) Pub. Date: May 29, 2025

(54) Image-Text Co-Decomposition for Text-Supervised Semantic Segmentation

(71) Applicant: MEDIATEK INC., Hsinchu City (TW)

(72) Inventors: Yen-Yu Lin, Hsinchu City (TW); Ji-Jia Wu, Taipei City (TW); Hou-Ning Hu, Hsinchu City (TW)

(73) Assignee: MEDIATEK INC., Hsinchu City (TW)

(21) Appl. No.: 18/961,469

(22) Filed: Nov. 27, 2024

Related U.S. Application Data
(60) Provisional application No. 63/602,692, filed on Nov. 27, 2023.

(51) Int. Cl. G06V 30/148; G06T 7/11

(52) U.S. Cl. CPC G06V 30/148; G06T 7/11; G06T 2207/20132

(57) ABSTRACT

A machine learning model includes an image-text co-segmentation module, a region-word highlighting module and a region-word alignment module. The image-text co-segmentation module is used to generate a word mask and a region mask for a selected noun in an input text. The region-word highlighting module is linked to the image-text co-segmentation module, and used to crop and highlight a text background in the input text according to the word mask to generate a highlighted text, and crop and highlight an image background in an input image according to the region mask to generate a highlighted image. The region-word alignment module is linked to the region-word highlighting module, and used to extract features from the highlighted text and the highlighted image.

### CROSS REFERENCE TO RELATED APPLICATIONS

This application claims the benefit of U.S. Provisional Application No. 63/602,692, filed on Nov. 27, 2023. The content of the application is incorporated herein by reference.

### FIELD OF INVENTION

The present invention relates to a vision-language model. In particular, the present invention relates to text-supervised semantic segmentation, aiming to learn a model capable of segmenting arbitrary visual concepts within images.

### BACKGROUND

Several important task applications of deep learning in the field of computer vision (CV) include image classification, object detection, and image segmentation. Image segmentation is used to detect and classify pixels in an image, and it can be used in tasks such as beauty makeup, portraits, autonomous driving, biomedicine, and smart animal husbandry.

Image segmentation includes semantic segmentation, instance segmentation, and panoptic segmentation. Semantic segmentation refers to classifying all pixels in the image. Instance segmentation is a combination of object detection and semantic segmentation, and the task is relatively difficult. The method is to classify the pixels of interest and locate each object. Even multiple objects in the same category will be segmented into different objects. Panoptic segmentation further combines semantic segmentation and instance segmentation. As the name suggests, it is to detect and segment each pixel while also taking the background into consideration.

Semantic segmentation is simply the task of assigning a class label to every single pixel of an input image. The defining feature of semantic segmentation that differentiates it from instance segmentation is that it does not distinguish between different objects that belong to the same class.

Semantic segmentation is essential to various applications in computer vision but is hindered by several critical challenges. First, the expensive cost of acquiring pixel-level annotations limits the applicability of fully supervised semantic segmentation methods. Second, most existing methods are developed to work on pre-defined categories and leave themselves inapplicable to rare or unseen concepts described by free-form text. To address these obstacles, a new research direction has emerged in vision-language models, referred to as text-supervised semantic segmentation. This task develops segmentation models capable of assigning labels across large vocabularies of concepts and supporting semantic segmentation model training without pixel-wise annotations.

### SUMMARY

An embodiment provides a device implementing a machine learning model. The device includes a segmentation module, and a selector. The segmentation module is used to receive an input image and input text, and output a segmented image, wherein the segmentation module at least segments the image. The selector is used to select a word in the texts. The segmentation module generates a segmented image corresponding to the image and the word.

An embodiment provides a device implementing a machine learning model. The device includes an image segmenter and a segmented texter. The image segmenter is used to receive an image and at least a word, and output a corresponding segmented image according to the image and the word. The segmented texter is used to receive a text and at least a word, and output a corresponding segmented text according to the text and the word.

An embodiment provides a device implementing a machine learning model. The device includes an image-text co-segmentation module, a region-word highlighting module, and a region-word alignment module. The image-text co-segmentation module is used to generate a word mask and a region mask for a selected noun in an input text. The region-word highlighting module is linked to the image-text co-segmentation module and used to crop and highlight a text foreground in the input text according to the word mask to generate a highlighted text, and crop and highlight an image foreground in an input image according to the region mask to generate a highlighted image. The region-word alignment module is connected to the region-word highlighting module and used to extract features from the highlighted text and the highlighted image.

A method for a machine learning model includes a segmentation module receiving an input image and input text, the segmentation module outputting a segmented image, a selector selecting a word in the texts, and the segmentation module generating a segmented image corresponding to the image and the word. The segmentation module at least segments the image.

A method for a machine learning model includes an image segmenter receiving an image and at least a word, the image segmenter outputting a corresponding segmented image according to the image and the word, a segmented texter receiving a text and at least a word, and the segmented texter outputting a corresponding segmented text according to the text and the word.

A method for a machine learning model includes an image-text co-segmentation module generating a word mask and a region mask for a selected noun in an input text, a region-word highlighting module cropping and highlighting a text foreground in the input text according to the word mask to generate a highlighted text, the region-word highlighting module cropping and highlighting an image foreground in an input image according to the region mask to generate a highlighted image, and a region-word alignment module extracting features from the highlighted text and the highlighted image.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a schematic diagram of an image-text alignment method according to an embodiment of the present invention.

FIG. 1B is a schematic diagram of region-text alignment method according to another embodiment of the present invention.

FIG. 1C is a schematic diagram of region-word alignment method according to another embodiment of the present invention.

FIG. 2 is a schematic diagram of a method of image-text co-decomposition according to an embodiment of the present invention.

FIG. 3 is a flowchart of a method of image-text co-decomposition according to an embodiment of the present invention.

FIG. 4 is a flowchart of a method of image-text decomposition according to an embodiment of the present invention.

FIG. 5 is a flowchart of a method of image-text co-decomposition according to an embodiment of the present invention.

### DETAILED DESCRIPTION

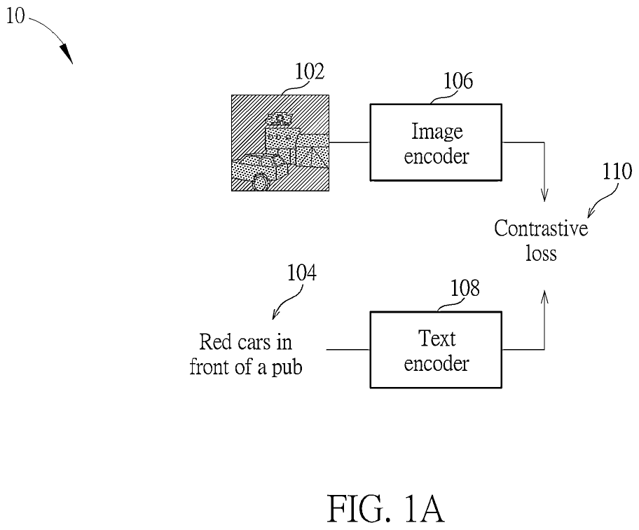

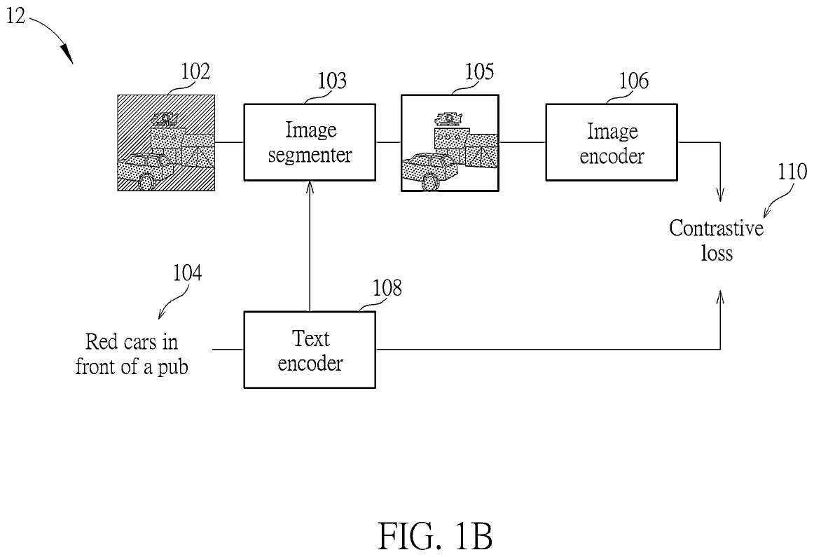

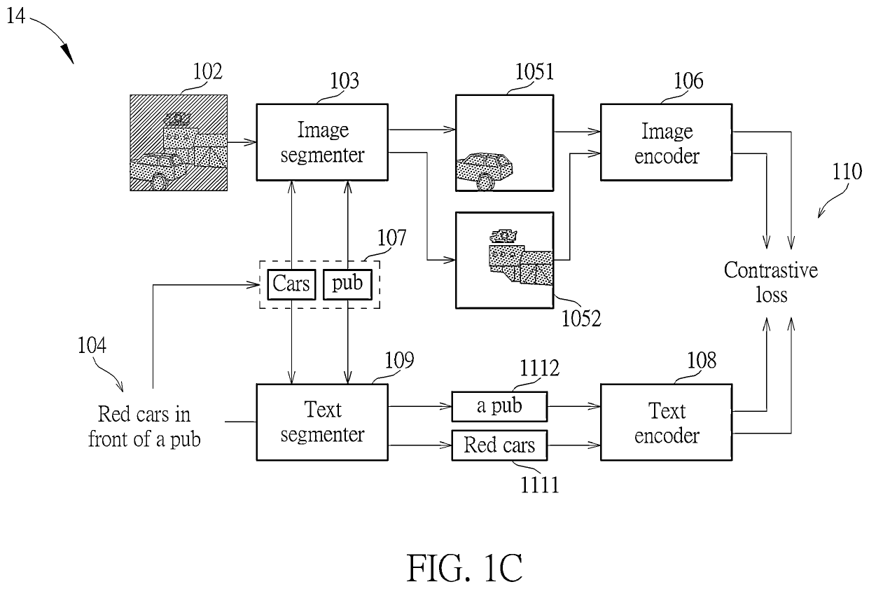

FIG. 1A is a schematic diagram of an image-text alignment method 10 according to an embodiment of the present invention. As depicted in FIG. 1A, methods of this group derive an image encoder and a text encoder by aligning them in a joint embedding space. They then use their proposed zero-shot transfer techniques to enable the two encoders to predict segmentation output. The method focuses on aligning text embeddings with image embeddings during training. An input image 102 is inputted into an image encoder 106 to generate a high dimensional image embedding. As an example, the input image 102 contains red cars and a pub, and the high dimensional image embedding includes the information of the red cars and the pub. An input text 104 is inputted into a text encoder 108 to generate a high dimensional text embedding. The input text 104 contains “red cars in front of a pub”, and the high dimensional text embedding includes the information of the red cars and the pub. The high dimensional image embedding and the high dimensional text embedding are compared to generate a contrastive loss 110 for a training process.

The image-text alignment method 10 derives an image encoder 106 and a text encoder 108 by aligning them in a joint embedding space. The method 10 then uses zero-shot transfer techniques to enable the two encoders to predict segmentation output. Despite the simplicity, the method 10 introduces unfavorable discrepancies between the training and testing phases since the target is to match the semantic features from the text to the corresponding image segments rather than the whole image during testing.

To mitigate this issue, FIG. 1B is provided. FIG. 1B is a schematic diagram of region-text alignment method 12 according to another embodiment of the present invention. An input text 104 is inputted into a text encoder 108 to generate a high dimensional text embedding. As an example, the input text 104 contains “red cars in front of a pub”, and the high dimensional text embedding includes the information of the red cars and the pub. The high dimensional text embedding and an input image 102 are inputted into an image segmenter 103 to generate an image segment (also called segmented image) 105 containing only red cars and the pub. The image segment 105 is then inputted into an image encoder 106 to generate a high dimensional image embedding. The image segment 105 contains only the red cars and the pub, and the high dimensional image embedding includes the information of the red cars and the pub. The high dimensional image embedding and the high dimensional text embedding are compared to generate a contrastive loss 110.

Method 10 introduces unfavorable discrepancies between the training and testing phases. In order to mitigate this issue, the region-text alignment method 12 is explored. As shown in FIG. 1B, the method 12 utilizes a pre-trained visual-language model to derive an image segmenter 103 that discovers concepts described by the text. The method 12 enforces the consistency between the segmented image 105 and the input text 104 but suffer from the discrepancy between the region-text alignment and semantic segmentation: an input text 104 may consist of multiple concepts, such as pub, nights, and cars in FIG. 1B, while semantic segmentation aims to identify regions of these concepts.

To address the issues in the image-text alignment method 10 and the region-text alignment method 12, a novel framework called image-text co-decomposition is proposed to achieve region-word alignment. FIG. 1C is a schematic diagram of region-word alignment method 14 according to another embodiment of the present invention. The region-word alignment method 14 includes a noun selector 107, an image segmenter 103, a segmented texter 109, an image encoder 106, and a text encoder 108. The noun selector 107 randomly selects a selected noun in the input text 104 such as cars and pub in FIG. 1C. Then, the selected noun and the input text 104 are fed into the segmented texter 109 to generate a segmented text such as “red cars” and “a pub”. After that, the segmented text is inputted into the text encoder 108 to generate a high dimensional text embedding. Meanwhile, the selected noun selected by the noun selector 107 and the input image 102 are inputted into the image segmenter 103 to generate an image segment containing only the red cars or the pub. Then, the image segment is inputted into the image encoder 106 to generate a high dimensional image embedding. The high dimensional text embedding and the high dimensional image embedding are compared to generate a contrastive loss 110 for a training process. The noun selector may be configured to allow the user to manually define or specify the word during use. In another example, the selected noun is predetermined.

As illustrated in FIG. 1C, a visual-language model is utilized to construct an image segmenter 103 and a segmented texter 109. The image segmenter 103 decomposes an input image 102 into image segments 1051, 1052, while the segmented texter 109 decomposes an input text 104 into word segments 1111, 1112. In addition, there exist one-to-one correspondence between image segments 1051, 1052 and word segments 1111, 1112. In this way, the discrepancy between training and testing is alleviated since each image segment 1051, 1052 is derived from a single concept given by the corresponding word segment 1111, 1112. A person skilled in the art understands that number of the image segments and the segmented texts are for illustrates only.

For each selected noun such as “car”, the image segmenter 103 identifies the image segment 1051 matching the noun, i.e., the region of the “car”, while the segmented texter 109 discovers the corresponding word segment 1111, i.e., “red cars”. For the selected noun such as “pub”, the image segmenter 103 identifies the image segment 1052 matching the noun, i.e., the region of the “pub” noun, i.e., the region of the “pub”. The region-word alignment method 14 is developed to enforce the consensus between the image and word segments. To better work with a vision-language model, the proposed invention presents a prompt learning module to derive an extra representation with which more effective features can be extracted.

To better understand the proposed invention, some related technical descriptions are reviewed as follows.

### Open-Vocabulary Semantic Segmentation

Open-vocabulary semantic segmentation focuses on segmenting any concepts within images, even those unseen during training, based solely on textual descriptions. Its three important branches are discussed as follows:

Semi-Supervised Setting with Mask-Annotations

Methods of semi-supervised setting with mask-annotations learn from dense annotations to produce high-quality segmentation masks, and then utilize image-text pairs and pre-trained vision-language models to extend the segmentation capability to a larger target vocabulary. Despite the remarkable results, these methods are hindered by their reliance on costly dense annotations, posing a challenge in cases where such annotations are difficult to obtain.

Training-free methods: Another line of research makes the most of large pre-trained models for open-vocabulary segmentation without training. A method of semi-supervised setting with mask-annotations introduces a heuristic modification to the final layer of the CLIP image encoder, yielding dense feature maps that could be employed as initial segmentation maps for further refinement. A method of semi-supervised setting with mask-annotations constructs an image archive and makes use of retrieval and co-segmentation to identify co-occurrence regions among a specific category. Although these methods eliminate the use of training and prioritize a straightforward architecture, the results exhibit significant room for improvement, which shows the need for additional supervision to accomplish this task.

### Text-Supervised Semantic Segmentation

It strikes a balance between the two aforementioned branches. Methods of this group are discussed in detail as follows.

Text-supervised semantic segmentation decomposes an image into semantic regions according to text descriptions. Unlike semi-supervised methods relying on a few images with mask annotations during training, methods of this group aim to learn semantic masks solely from text-based guidance. Existing methods can be roughly divided into two categories based on their cross-modal alignment between the image and text domains.

### Image-Text Alignment

These methods train an image encoder alongside a text encoder to align pairs of image and text in a joint embedding space. They use zero-shot transfer to enable the encoders to produce segmentation results.

Region-text alignment: Another line of research targets at aligning the embedding of a region, instead of the whole image, with text descriptions. For instance, a method learns to segment specific regions within an image while ensuring consistency between the segmented region and the original text. It enables the model to segment the relevant region described in the text. These methods for text-supervised semantic segmentation have shown that employing vision-language models and contrastive learning on image-text pairs enables aligning visual concepts with the meaning of the whole text. It is noticed that a text is usually a mix of multiple semantic concepts, but semantic segmentation aims to discover semantically homogeneous segments. To address this issue, we introduce image-text co-decomposition, where the image and the text are decomposed into image and word segments, respectively, and contrastive learning is adopted to enforce cross-modal consensus between these image and word segments. It turns out that the image-text co-decomposition results in consistent performance gains on multiple benchmarks.

### Prompt Tuning for Vision-Language Models

Emerged from natural language processing, the prompt tuning focuses on parameter-efficient adaptation of large pre-trained models to generate new tasks. In computer vision, pioneering work such as CoOp incorporates learnable tokens into the CLIP text encoder, enhancing the classification task performance. Recent studies leverage prompt tuning in the text modality for extending CLIP's capabilities to various applications such as object detection and semantic segmentation. Notably, prompt learning methods are also applicable to the visual domain. VPT (vision prompt tuning) employs prompt tuning in the visual modality by inserting learnable vectors into Vision Transformers. Further studies explore tuning methods that directly incorporate learnable prompts into the input image within the RGB domain to address downstream tasks.

Drawing inspiration from the success of these methods, the proposed method leverages the capabilities of prompt tuning on segment feature extraction in both the visual and text domains. Prompt learning is beneficial in the proposed method when applying contrastive learning to the visual and textual features extracted by a vision-language model.

The proposed invention provides a method for image-text co-decomposition. Three major modules are provided, including 1) the image-text co-segmentation module, 2) the region-word highlighting module, and 3) the region-word alignment module. These modules can work independently or in combination. Each module can be an individual method that can be implemented independently, or combined with other modules/methods. For example, the methods and modules in FIG. 1B or FIG. 1C can be combined with Module 1 or 2. These modules work harmoniously to address the region-word alignment for text-supervised semantic segmentation and enhance model performances.

### Method Overview

Image-text co-decomposition enables text-supervised segmenters to learn region-word consensus when segmenting an image X^{v} with a paired text X^{t}. The proposed method aims to jointly learn an image segmenter F^{v} and a segmented texter F^{t} with solely the supervision from a set of K image-text pairs, D={Xₖ^{u},Xₖ^{t}}ₖ₌₁^{K}. In addition, the proposed method optimizes two learnable prompts, including a region prompt P^{v} and a word prompt P^{t}, to alleviate the unfavorable effect of blank embeddings caused by applying a vision-language model to masked images or texts for feature extraction.

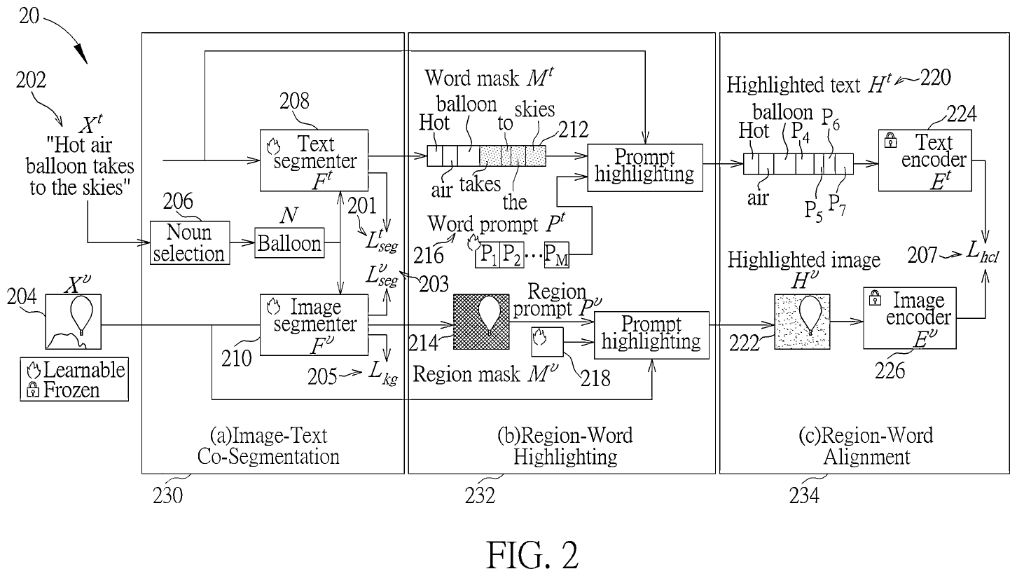

FIG. 2 illustrates the pipeline of the proposed method, consisting of three modules, including the image-text co-segmentation, region-word highlighting, and region-word alignment modules. For an input image-text pair (X^{v},X^{t}), the proposed method initiate the process by randomly selecting a noun N, e.g., balloon in the figure, from the text X^{t} using the rule-based noun selector. This selected noun serves as a query. The proposed method take the query N along with the image X^{v} as input to the image segmenter F^{v} to generate the region mask M^{v} showing the estimated object region specified by the query. Similarly, a segmented texter F^{t} takes the query N and the text X^{t} as input and estimates the word mask M^{t} indicating the associated word segment.

Subsequently, the proposed method applies the region mask M^{v} to the image X^{v} to crop the estimated object region. For the estimated background, i.e., the region outside the mask M^{v}, the proposed method crops the corresponding region from the learned region prompt P^{v}. The highlighted image H^{v} is yielded by combining the segmented object and background regions. Similarly, the highlighted text H^{t} is generated by combining the text X^{t} inside the mask M^{t} and the word prompt P^{t} outside the mask M^{t}. The proposed method extracts features from the highlighted image and text by using the image encoder E^{v} and the text encoder E^{t}, respectively. The procedure is repeated for each image-text pair and each selected noun. It follows that the region-word alignment is accomplished by contrastive learning. Four loss functions, including L_{kg}, L^{v}_{seg}, L^{t}_{seg}, and L_{hcl}, are used for network optimization, and will be elaborated in the following.

### Image-Text Co-Segmentation

The image-text co-segmentation module comprises a rule-based noun selector, an image segmenter, and a segmented texter, as shown in FIG. 2(a). Taking an image-text pair (X^{v},X^{t}) as input, this module aims at jointly identifying an object region in image X^{v} and its accompanying word segment in text X^{t} according to a randomly selected noun.

To begin with, the proposed method employs the rule-based noun selector, which takes the text X^{t} as input and extracts a set of J nouns, {Nⱼ}ⱼ₌₁^{J}, in X^{t}. For each noun Nⱼ, the proposed method carry out region mask generation, where the image segmenter F^{v} predicts a region mask M^{v} specifying the area in image X^{v} relevant to noun Nⱼ. A similar task word mask generation is performed by the segmented texter F^{t}, which seeks a word mask M^{t} matching noun Nⱼ. The tasks of region and word mask generation are depicted as follows. It is understandable that, the rule-based noun selector can also select other words other than noun that specified in advance or on actual desire. Also, in other embodiments, the input of the rule-based noun selector can be noun, word, or phrase. Different kinds of inputs are referred to “noun” or “word” in this document for simplicity.

Region mask generation. The image segmenter F^{v} takes image X^{v} and noun Nⱼ as input. It encodes the image into a pixel-wise embedding x^{v}∈ [symbol] ^{H×W×C}, where H×W is the image resolution and C is the channel dimension. The proposed method also computes the noun embedding nⱼ∈ [symbol] ^{C} for noun Nⱼ. The image segmenter generates a region mask M^{v} ∈ [symbol] ^{R×W} by performing the dot product between the noun embedding nⱼ and every location of the image embedding x^{v}.

The proposed method uses the image segmentation model, and employs its corresponding loss, denoted by L^{v}_{seg} here, to help derive the image segmenter. This loss considers segment regularization and contrastive learning that can be directly applied to the segmentation results along with the noun embedding. The proposed method obtains the noun embedding nⱼ, as it avoids the pitfalls of improper prompt selection. It appends learnable context tokens to the noun, forming pseudo-sentences for optimal prompt tuning. The noun embedding loss L_{kg} is included to improve the accuracy of these embeddings. It is understood that there are various methods to compute embedding loss, so a detailed explanation is not provided here.

Word mask generation. The segmented texter F^{t} takes the text X^{t} and the noun Nⱼ as input for text feature extraction. For example, the CLIP text encoder appended with two learnable multi-head attention layers can be used. With the resultant feature extractor Ē^{t}, the word-wise features of text X^{t} are obtained via x^{t}=Ē^{t} (X^{t})∈ [symbol] ^{L×C}, where L is the text length, i.e., the number of word tokens. The word-specific logits [symbol] ⱼ=[ [symbol] _{j,i}]ᵢ₌₁^{L}∈ [symbol] ^{L} for noun Nⱼ are computed via

$${ℓ}_{j} = w \cdot {x}^{t} {n}_{j} + b ,$$

where w and b are two learnable parameters, and nj∈RC is the noun embedding.

Since each word in text X^{t} belongs to either one of the J word segments associated with nouns {Nⱼ}ⱼ₌₁^{J} or none of them, the word mask M^{t}=[mᵢ^{t}]ᵢ₌₁^{L}∈ [symbol] ^{L} for noun Nⱼ is obtained by applying the softmax function over all the J noun-associated segments. It is understood that there are various methods to compute word mask, and a detailed explanation is not provided here.

The proposed method gets the probabilities of word i over J+1 cases, namely belonging to one of the J noun-associated segments or none of them. The proposed method compile a pseudo label vector p={pi}∈{0,1}^{L}, where pᵢ takes value 1 if word i belonging to the jth noun-associated segment gets the highest probability, and 0 otherwise. The proposed method develop the segmented textation loss L^{t}_{seg}, which is the cross-entropy loss on the word mask M^{t} with respect to the pseudo label vector p, and can help learn the segmented texter F^{t}.

### Region-Word Highlighting

The proposed method presents a prompt learning method to reliably extract features from an image region or a word segment using a vision-language model. Specifically, the proposed method proposes a region-highlighting prompt learning method and a word-highlighting prompt learning method, as shown in FIG. 2(b).

Region highlighting prompt. When the region mask M^{v} is directly applied to the image X^{v} via M^{v}*X^{v}, where * denotes the element-wise multiplication operation, it makes specific regions of the image being zeroed out, resulting in what the proposed method refers to as blank areas. When a pre-trained vision-language model (CLIP, for example) is applied to these areas, the domain distribution may shift due to the introduction of zero tokens, which are unseen in natural images. To mitigate this issue, The proposed method introduces a region highlighting prompt, which is a learnable, universal region representation, denoted by P^{v}, to obtain a highlighted image H^{v}. This representation is used alongside the original image in the process of feature extraction. The highlighted image H^{v} is then obtained via

$${H}^{v} = {X}^{v} * {M}^{v} + {P}^{v} * ( 1 - {M}^{v} ) . \qquad ( 4 )$$

In this way, the blank areas are filled with the corresponding areas of the region prompt P^{v} alleviating the unfavorable effect of domain shift.

Word highlighting prompt. A similar challenge arises in the text domain when applying the word mask M^{t} to text X^{t}. The resultant zero tokens in the masked part unintentionally carry meanings of specific words, leading to potential inaccuracies. To mitigate this issue, the proposed method introduces a word highlighting prompt, represented as a learnable, universal text representation P^{t}, to obtain a highlighted text H^{t}. The highlighted text H^{t} is obtained by

$${H}^{t} = {X}^{t} * {M}^{t} + {P}^{t} * ( 1 - {M}^{t} ) . \qquad ( 5 )$$

Since the masked part is filled with content from the word prompt P^{t}, the risk of including unexpected text meanings can be reduced.

### Region-Word Alignment

In the following, the proposed method describe how it achieves region-word alignment. The objective is to optimize mutual evidence between the highlighted object regions and the highlighted word segments, as illustrated in FIG. 2(c).

Contrastive loss on highlighted region-word pairs. To achieve region-word alignment, the proposed method computes the highlighted region embedding cv and highlighted word segment embedding e^{t} from the highlighted region-word pair by using the image and text encoders of CLIP by

$${e}^{v} = {E}^{v} ( {H}^{v} ) and {e}^{t} = {E}^{t} ( {H}^{t} ) , \qquad ( 6 )$$

where E^{v} and E^{t} are the CLIP image and text encoders, respectively.

The proposed method adopts batch optimization for model training. Each batch has several triplets, each of which is composed of an image, its paired text, and a randomly selected noun from the text. Each triplet yields a region embedding and a word embedding. Suppose that there are B triplets in this batch. The proposed method create a similarity matrix S=[S_{i,j}]∈ [symbol] ^{B×B}, where S_{i,j} stores the cosine similarity between the ith region embedding eᵢ^{v}, and the jth word segment embedding eᵢ^{v}. In one example, the proposed method adopts the symmetric version of InfoNCE loss to develop the highlighted region-word pair contrastive loss, which enhances the similarity of related region-word pairs while reducing it for unrelated pairs

Loss functions and optimization. In sum, the proposed network for image-text co-decomposition is optimized using a composite loss that combines the knowledge-guided, image segmentation, segmented textation, and highlighted region-word pair contrastive losses, defined as follows:

$$ℒ = {λ}_{kg} {ℒ}_{kg} + {λ}_{seg}^{v} {ℒ}_{seg}^{v} + {λ}_{seg}^{t} {ℒ}_{seg}^{t} + {λ}_{hcl} {ℒ}_{hcl} . \qquad ( 8 )$$

FIG. 2 is a schematic diagram of a method 20 of image-text co-decomposition according to an embodiment of the present invention. The method 20 of image-text co-decomposition includes an image-text co-segmentation module 230, a region-word highlighting module 232 and a region-word alignment module 234. The image-text co-segmentation module 230 is used to generate a word mask 212 and a region mask 214 for a selected noun in an input text 202. The region-word highlighting module 232 is connected to the image-text co-segmentation module 230 to generate a highlighted text 220, and a highlighted image 222. The text background is a complementary of the segmented text, and the image background is a complementary of the segmented image. For example, the text background “0 0 0 takes to the skies” is a complementary of the segmented text “Hot air balloon 0 0 0 0”. In an embodiment, the text background is filtered from the input text 202 by the word mask 212. For example, the word mask is “1110000” and the input text 202 is “Hot air balloon takes to the skies”. Then, the highlighted text 220 can be generated by the word mask 212 as “Hot air balloon P4 P5 P6 P7”, and the text background can be generated as “X X X takes to the skies”. In the same concept, the highlighted image 222 and the image background can be generated by the region mask 214 and the input image 204. The region-word alignment module 234 is connected to the region-word highlighting module 232, and compares the outputs of the text encoder 224 and image encoder 226 to computes the loss.

The image-text co-segmentation module 230 includes a noun selector 206, a segmented texter 208 and an image segmenter 210. The noun selector 206 is used to randomly select a selected noun in the input text 202. For example, “balloon” and “skies” can be the selected nouns in FIG. 2. The segmented texter 208 is linked to the noun selector 206, and used to generate the word mask 212 and a segmented textation loss 201 according to the selected noun and the input text 202. The segmented textation loss 201 is the cross-entropy loss on the word mask 212 to derive the segmented texter 208. The image segmenter 210 is linked to the noun selector 206, and used to generate the region mask 214, a visual segmentation loss 203 and a noun embedding loss 205 according to the selected noun and the input image 204. The noun embedding loss 205 is included to improve the accuracy of selected noun embeddings. The visual segmentation loss 203 considers segment regularization and contrastive learning to derive the image segmenter 210. The relationship between the region mask 214 and the word mask 212 can be aligned due to the same selected noun selected by the noun selector 206. In an embodiment, the noun selector 206 is pre-trained, and the segmented texter 208 and the image segmenter 210 are trained in a training process according to the segmented textation loss 201, the visual segmentation loss 203, the noun embedding loss 205 and a highlighted region-word pair contrastive loss 207.

The region-word highlighting module 232 generates the text background according to the input text 202 and the word mask 212, and replaces the text background in the input text 202 with a word prompt 216 to generate the highlighted text. For example, the word prompt 216 is “P1 P2 P3 P4 P5 P6 P7” and the word mask 212 is “1 1 1 0 0 0 0”, then the highlighted text 220 is generated as “Hot air balloon P4 P5 P6 P7”. The text background “0 0 0 1 1 1 1” is replaced with the word prompt 216 “P1 P2 P3 P4 P5 P6 P7”. The region-word highlighting module 232 generates the image background according to the input image 204 and the region mask 214, and replaces the image background in the input image 204 with a region prompt 218 to generate the highlighted image 222 by the similar way as using word prompt 216. The word prompt 216 and the region prompt 218 are trained in the training process according to the segmented textation loss 201, the image segmentation loss 203, the noun embedding loss 205 and the highlighted region-word pair contrastive loss 207.

The region-word alignment module 234 includes a text encoder 224 and an image encoder 226. The text encoder 224 is used to extract text features from the highlighted text 220 to generate a high dimensional text embedding. The image encoder 226 is used to extract image features from the highlighted image 222 to generate a high dimensional image embedding and a highlighted region-word pair contrastive loss 207 by comparing the high dimensional text embedding and the high dimensional image embedding. The highlighted text 220 and the highlighted image 222 are projected into a joint dimension so that the information in the highlighted text 220 and the highlighted image 222 can be compared to generate the highlighted region-word pair contrastive loss 207. Therefore, the machine learning model can be trained in the training process according to the segmented textation loss 201, the image segmentation loss 203, the noun embedding loss 205 and the highlighted region-word pair contrastive loss 207. In an embodiment, the text encoder 224 and the image encoder 226 are pre-trained and fixed.

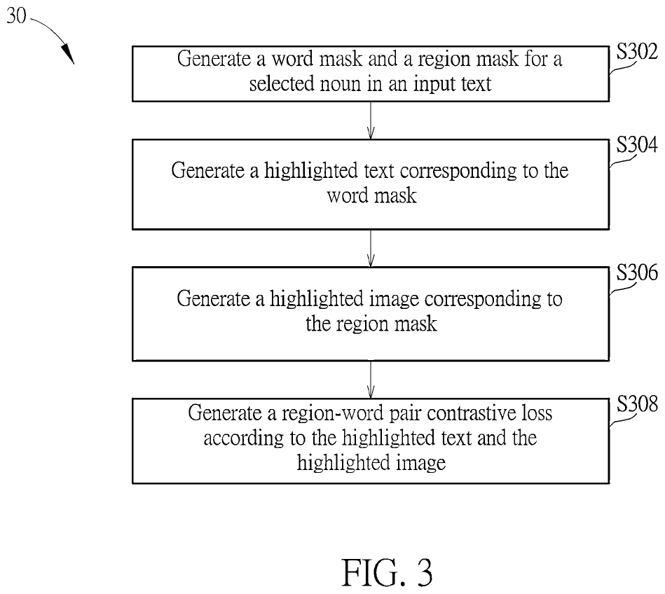

FIG. 3 is a flowchart of a method 30 of image-text co-decomposition according to an embodiment of the present invention. The method 30 includes the following steps:
Step S302: Generate a word mask and a region mask for a selected noun in an input text;
Step S304: generate a highlighted text corresponding to the word mask;
Step S306: generate a highlighted image corresponding to the region mask; and
Step S308: generate a region-word pair contrastive loss according to the highlighted text and the highlighted image;

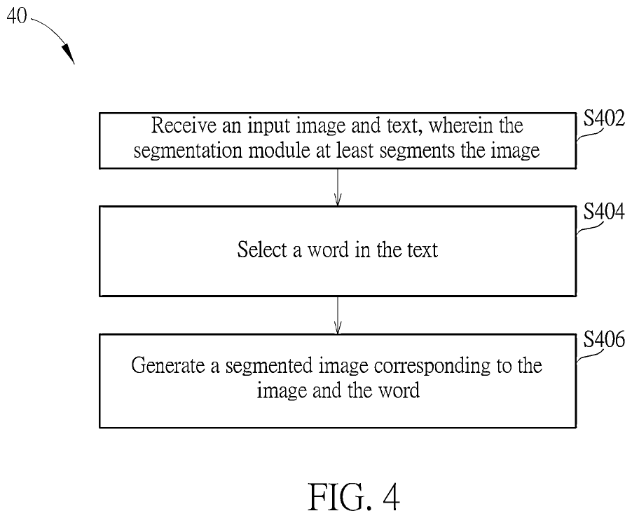

FIG. 4 is a flowchart of a method 40 of image-text decomposition according to an embodiment of the present invention. The method 40 includes the following steps:
Step S402: receive an input image and text, wherein the segmentation module at least segments the image;
Step S404: select a word in the text; and
Step S406: generate a segmented image corresponding to the image and the word.

In another embodiment, the image-text decomposition method further generates a region-word pair contrastive loss according to the segmented image and the word.

In another embodiment, the segmentation module is adjusted according to the contrastive loss.

In another embodiment, the image-text decomposition method further segment the text, and the segmentation module is an image-segmented textation module, which segments both the image and the texts.

In another embodiment, the image-text decomposition method further generates a region-word pair contrastive loss according to the segmented image and segmented text.

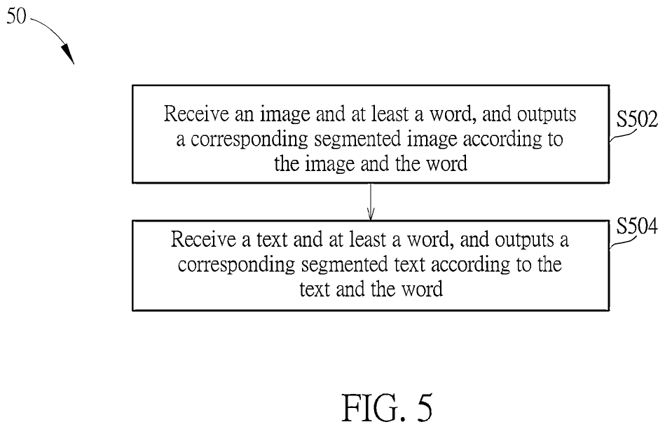

FIG. 5 is a flowchart of a method 50 of image-text co-decomposition according to an embodiment of the present invention. As an improvement of method 40, method 50 is provided as follows:
Step S502: receive an image and at least a word, and outputs a corresponding segmented image according to the image and the word; and
Step S504: receive a text and at least a word, and outputs a corresponding segmented text according to the text and the word.

In another embodiment, the image-text co-decomposition method further provides a word to the image segmenter and the segmented texter through a selector, wherein the word is predetermined or defined by the user.

The proposed method introduces Image-Text Co-Decomposition (CoDe) to address cross-domain alignment discrepancies in the existing methods for text-supervised semantic segmentation. In one embodiment, the proposed method decomposes image-text pairs into corresponding region and word segments to enforce the region-word alignment. CoDe, underpinned by contrastive learning, alleviates the train-test discrepancy by unifying image-text and region-text alignments to region-word alignment. In another example, the proposed method introduces a region-highlighting prompt learning method to enhance feature extraction on masked images or texts for precise region-word alignment. Moreover, CoDe surpasses state-of-the-art methods in zero-shot semantic segmentation. This novel approach opens new possibilities for research in vision-language models and their broader applications in computer vision.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A device, implementing a machine learning model, the device comprising:
a segmentation module, configured to receive an input image and input text, and output a segmented image, wherein the segmentation module at least segments the image;
a selector, configured to select a word in the texts; and
the segmentation module generates a segmented image corresponding to the image and the word.

2. The device of claim 1, further comprising an image encoder, configured to encode the segmented image for contrastive loss.

3. The device of claim 1, wherein the segmentation module further segments the text, and a segmented text is generated according to the selected word and the text.

4. The device of claim 1, wherein the segmentation module is an image-text co-segmentation module, which segments both the image and the texts.

5. A device, implementing a machine learning model, the device comprising:
an image segmenter, configured to receive an image and at least a word, and output a corresponding segmented image according to the image and the word; and
a segmented texter, configured to receive a text and at least a word, and output a corresponding segmented text according to the text and the word.

6. The device of claim 5, further includes a selector, configured to select, and provide the word to the image segmenter and the segmented texter.

7. The device of claim 5, further comprises an image encoder, configured to encode the segmented image; and
a text encoder, configured to encode the segmented text, wherein a region-word pair contrastive loss is generated according to the segmented image and the segmented text.

8. The device of claim 5, wherein the word is predetermined or defined by the user.

9. A device, implementing a machine learning model, the device comprising:
an image-text co-segmentation module, configured to generate a word mask and a region mask for a selected noun in an input text;
a region-word highlighting module, linked to the image-text co-segmentation module, and configured to crop and highlight a text foreground in the input text according to the word mask to generate a highlighted text, and crop and highlight an image foreground in an input image according to the region mask to generate a highlighted image; and
a region-word alignment module, connected to the region-word highlighting module, and configured to extract features from the highlighted text and the highlighted image.

10. The device of claim 9, wherein the image-text co-segmentation module comprises:
a selector, configured to select a selected noun in the input text;
a segmented texter, linked to the noun selector, and configured to generate the word mask and a segmented textation loss according to the selected noun and the input text; and
an image segmenter, linked to the noun selector, and configured to generate the region mask, a visual segmentation loss and a noun embedding loss according to the selected noun and the input image.

11. The device of claim 10, wherein:
the region-word highlighting module generates the text foreground according to the input text and the word mask, and replaces the text background in the input text with a word prompt to generate the highlighted text; and
the region-word highlighting module generates the image foreground according to the input image and the region mask, and replaces the image background in the input image with a region prompt to generate the highlighted image.

12. The device of claim 10, wherein the region-word alignment module comprises:
a text encoder configured to extract text features from the highlighted text; and
an image encoder configured to extract image features from the highlighted image and generate a highlighted region-word pair contrastive loss by comparing the text features and the image features.

13. A method for a machine learning model, the method comprising:
a segmentation module receiving an input image and input text;
the segmentation module outputting a segmented image, wherein the segmentation module at least segments the image;
a selector selecting a word in the texts; and
the segmentation module generating a segmented image corresponding to the image and the word.

14. The method of claim 13, further comprising an image encoder encoding the segmented image for contrastive loss.

15. The method of claim 13, further comprising:
the segmentation module segmenting the text; and
generating a segmented text according to the selected word and the text.

16. A method for a machine learning model, the method comprising:
an image segmenter receiving an image and at least a word;
the image segmenter outputting a corresponding segmented image according to the image and the word;
a segmented texter receiving a text and at least a word; and
the segmented texter outputting a corresponding segmented text according to the text and the word.

17. The method of claim 16, further comprising:
a selector selecting and providing the word to the image segmenter and the segmented texter.

18. The method of claim 16, further comprising:
an image encoder encoding the segmented image; and
a text encoder encoding the segmented text;
wherein a region-word pair contrastive loss is generated according to the segmented image and the segmented text.

19. A method for a machine learning model, the method comprising:
an image-text co-segmentation module generating a word mask and a region mask for a selected noun in an input text;
a region-word highlighting module cropping and highlighting a text foreground in the input text according to the word mask to generate a highlighted text;
the region-word highlighting module cropping and highlighting an image foreground in an input image according to the region mask to generate a highlighted image; and
a region-word alignment module extracting features from the highlighted text and the highlighted image.

20. The method of claim 19, further comprising:
a selector selecting a selected noun in the input text;
a segmented texter generating the word mask and a segmented textation loss according to the selected noun and the input text; and
an image segmenter generating the region mask, a visual segmentation loss and a noun embedding loss according to the selected noun and the input image.

21. The method of claim 20, wherein:
the region-word highlighting module generates the text foreground according to the input text and the word mask, and replaces the text background in the input text with a word prompt to generate the highlighted text; and
the region-word highlighting module generates the image foreground according to the input image and the region mask, and replaces the image background in the input image with a region prompt to generate the highlighted image.

22. The device of claim 20, further comprising:
a text encoder extracting text features from the highlighted text; and
an image encoder extracting image features from the highlighted image and generating a highlighted region-word pair contrastive loss by comparing the text features and the image features.
